(19) United States
(12) Patent Application Publication
(10) Pub. No.: US 2002/0108604 A1
(43) Pub. Date: Aug. 15, 2002

(54) Venting device

(76) Inventors: Markus Distelhoff, Griesheim (DE); Stefan Fuhling, Dortmund (DE); Justus Kloker, Neu-Anspach (DE); Knut Meyer, Essen (DE); Thomas Zapp, Dortmund (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/026,073

(22) Filed: Dec. 24, 2001

(30) Foreign Application Priority Data
Dec. 22, 2000 (DE) 100 64 592.5

(51) Int. Cl. F02M 25/08

(52) U.S. Cl. 123/520

(57) ABSTRACT

A venting device for a fuel tank of a motor vehicle includes a compressor for sucking gases out of the fuel tank and delivering them into a pressure vessel. When the motor vehicle is stationary, the pressure inside the fuel tank can be regulated by suitably controlling of the compressor. Gases that have collected in the pressure vessel are fed to an internal-combustion engine of the motor vehicle.

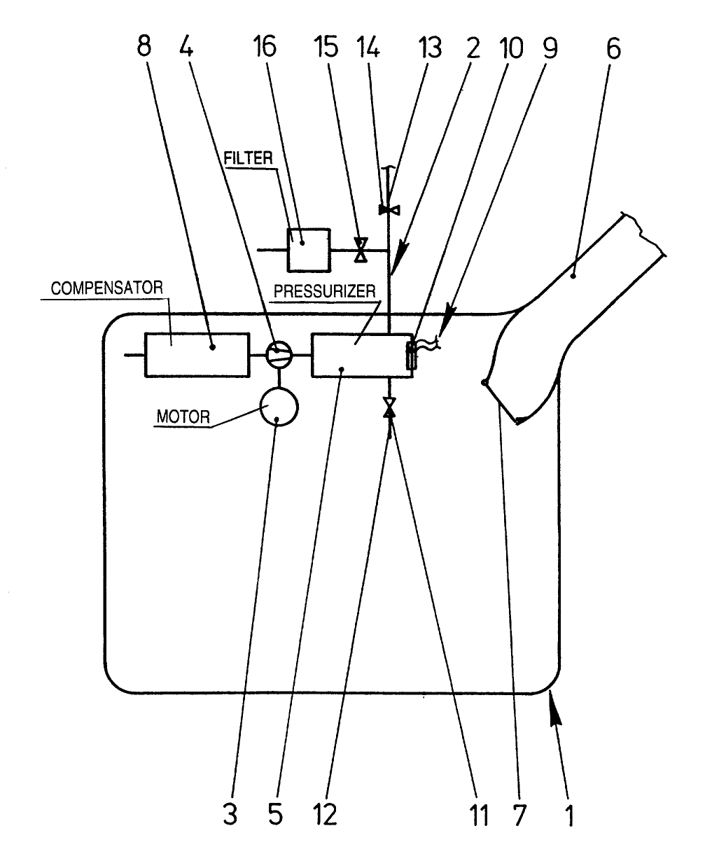

### BACKGROUND OF THE INVENTION

1. Field of the Invention

The invention relates to a venting device for a fuel tank of a motor vehicle.

Venting devices used in current motor vehicles have an activated carbon filter that is connected to the fuel tank. When the fuel tank is being refueled and in the event of a build-up of pressure in the fuel tank caused, for example, by an increase in temperature, gases are passed out of the fuel tank through the activated carbon filter into the environment. In operation, the activated carbon filter can be purged with fresh air, and fuel that has collected can be fed to an internal-combustion engine of the motor vehicle. The activated carbon filter adsorbs the fuel from the gases and prevents fuel vapors from reaching the environment.

However, a drawback of the prior art venting device is that the activated carbon filter, in particular, during long stationary phases of the motor vehicle, can become saturated, and, then, fuel vapors can pass unimpeded into the environment.

### SUMMARY OF THE INVENTION

It is accordingly an object of the invention to provide a venting device that overcomes the hereinafore-mentioned disadvantages of the heretofore-known devices of this general type and that that reliably prevents fuel vapors from escaping into the environment.

With the foregoing and other objects in view, in a fuel tank, there is provided, in accordance with the invention, a venting device, including a pressure vessel for collecting gas from the fuel tank, and a compressor for drawing gases out of the fuel tank and delivering them to the pressure vessel, the compressor fluidically connected to the pressure vessel.

According to the invention, the problem of reliably preventing fuel vapors is solved by providing the compressor for sucking gases out of the fuel tank and for delivering them into a pressure vessel, and providing the pressure vessel for collecting the gases.

As a result of the configuration of the invention, gases in the fuel tank are sucked out by the compressor and are delivered into the pressure vessel and, therefore, are temporarily stored in the pressure vessel. Consequently, no fuel vapors pass into the environment. By way of example, actuation of the compressor can take place in stationary phases of the internal-combustion engine in a pressure-dependent manner and/or during the refueling operation. When the compressor is operating, the pressure within the fuel tank falls and the pressure within the pressure vessel rises. Therefore, the pressure within the fuel tank can easily be set by suitably controlling the compressor. The presence of the invention means that there is no need for an activated carbon filter within the pressure vessel. A further advantage of the venting device according to the invention lies in the fact that the compressor can be used to diagnose leaks from the tank. At a set sub-atmospheric pressure, a leak is detected by the power uptake of the compressor.

The maximum pressure in the pressure vessel may be reached in the event the motor vehicle is stationary for a particularly long time.

In accordance with another feature of the invention, the escape of fuel into the environment through a safety valve can be kept at a particularly low level if the pressure vessel has a fuel/gas separator or means for separating the fuel out of the collected gases.

In accordance with a further feature of the invention, fuel can be removed from the gases stored in the pressure vessel if the pressure vessel has a cooling device. The fuel can condense out in the cooling device.

In accordance with an added feature of the invention, the cooling device is particularly inexpensive if the cooling device has a Peltier element.

In accordance with an additional feature of the invention, the fuel tank and the venting device according to the invention have a very small surface area and a particularly small number of connections if the compressor and the pressure vessel are disposed inside the fuel tank. Such a configuration keeps diffusion of fuel out of the fuel tank at a particularly low level. Furthermore, the expensive laying of lines between the fuel tank and the pressure vessel is avoided. Such a configuration makes installation of the venting device according to the invention particularly simple.

In accordance with yet another feature of the invention, the pressure vessel can easily be emptied if the pressure vessel has a switchable outlet valve for transferring the collected fuel into the fuel tank. By way of example, the outlet valve may be switched electrically or as a function of a set pressure ratio between the pressure vessel and the fuel tank.

In accordance with yet a further feature of the invention, it is easy to reduce the pressure inside the pressure vessel if the pressure vessel is intended to be connected to an induction duct of an internal-combustion engine of the motor vehicle.

During refueling of the fuel tank and when the internal-combustion engine is stationary, the gases are reliably collected in the pressure vessel if, in accordance with yet an added feature of the invention, a line of the pressure vessel, which leads to the induction duct of the internal-combustion engine, has a switching valve.

In the event of an excess pressure in the pressure vessel, fuel vapors are reliably prevented from escaping into the environment if, in accordance with yet an additional feature of the invention, the line that leads to the induction duct of the internal-combustion engine is connected to an activated carbon filter. Because, by virtue of the invention, a large proportion of the fuel vapors formed is collected in the pressure vessel before an excess pressure forms in the pressure vessel, the activated carbon filter only has to have very small dimensions. Because the activated carbon filter in the case of the invention, unlike in the prior art venting device, has no effect on the pressure inside the fuel tank, the invention avoids a rise in pressure in the fuel tank that is caused by the activated carbon filter when the fuel tank is being refueled.

According to another advantageous refinement of the invention, it is easy to avoid a constant load on the activated carbon filter from fuel vapors if a pressure-relief valve is disposed upstream of the activated carbon filter.

In accordance with again another feature of the invention, the pressure vessel has a line with a switching valve.

In accordance with again a further feature of the invention, there is provided an activated carbon filter fluidically connected to the line.

In accordance with again an added feature of the invention, there is provided a pressure-relief valve connected between the line and the activated carbon filter.

In accordance with again an additional feature of the invention, a sub-atmospheric pressure in the fuel tank can be reliably avoided if the fuel tank has a vent valve that opens in the event of a sub-atmospheric pressure.

With the objects of the invention in view, in a motor vehicle having a fuel tank and an internal-combustion engine with an induction duct, there is also provided a fuel tank venting device including a pressure vessel for collecting gas in the fuel tank and a compressor for drawing gases out of the fuel tank and delivering them to the pressure vessel, the compressor fluidically connected to the pressure vessel, the pressure vessel fluidically connected to the induction duct.

With the objects of the invention in view, there is also provided a fuel tank venting device including a pressure vessel for collecting gas in the fuel tank and a compressor for drawing gases out of the fuel tank and delivering them to the pressure vessel, the compressor fluidically connected to the pressure vessel.

Other features that are considered as characteristic for the invention are set forth in the appended claims.

Although the invention is illustrated and described herein as embodied in a venting device, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

The figure is a diagrammatic cross-sectional view of the venting device according to the invention.

### DESCRIPTION OF THE PREFERRED EMBODIMENTS

The drawing provides a single diagrammatic figure illustrating a fuel tank 1 with a venting device 2 according to the invention. The venting device 2 has a compressor 4, which is disposed inside the fuel tank 1 and is driven by an electric motor 3, and a pressure vessel 5, which is likewise disposed inside the fuel tank 1. The fuel tank 1 has a filler neck 6 with a back-surge flap 7. Upstream of the compressor 4, as seen in the direction of flow, there is a compensation vessel 8 that is connected to the fuel tank 1. In the compensation vessel 8, gases are separated from liquid fuel, thus preventing liquid fuel from being sucked in by the compressor 4. The pressure vessel 5 has a cooling device 9 with a Peltier element 10. The bottom region of the pressure vessel 5 is connected to the fuel tank 1 through a line 12 that can be closed off by an outlet valve 11. A line 13 leads from the upper region of the pressure vessel 5 to a non-illustrated induction duct of an internal-combustion engine. The line 13 can optionally be closed or opened by a switching valve 14. Between the switching valve 14 and the pressure vessel 5, a branch leads off through a pressure-relief valve 15 to an activated carbon filter 16.

The compressor 4 sucks gases out of the compensation vessel 8 and delivers them into the pressure vessel 5. The gases that have been sucked in are collected in the pressure vessel 5, where they are cooled by the cooling device 9. As a result, when the internal-combustion engine is stationary, there are no gases passing into the environment. Some of the fuel condenses out of the gases that have been sucked in inside the pressure vessel 5 and collects in the bottom region of the vessel 5. Gases that have collected in the pressure vessel 5 are fed to the induction duct of the internal-combustion engine when the engine is operating. The electric motor 3 that drives the compressor 4 may be activated, for example, when the surge-back flap 7 is opened during refueling of the fuel tank 1 and otherwise as a function of the pressure inside the fuel tank 1. The outlet valve 11 disposed in the line 12 that connects the bottom region of the pressure vessel 5 to the fuel tank 1 may, for example, be opened once a set pressure difference between the pressure vessel 5 and the fuel tank 1 is exceeded. In such an event, the collected fuel is passed back into the fuel tank 1. In the event of an excess pressure within the pressure vessel 5, the pressure-relief valve disposed between the activated carbon filter 16 and the pressure vessel 5 opens. Therefore, the pressure-relief valve 15 serves only as a safety valve. As such, the activated carbon filter 16 can be dispensed with if the pressure vessel 5 is sufficiently large.

We claim:

1. In a fuel tank, a venting device, comprising:
a pressure vessel for collecting gas from the fuel tank; and
a compressor for drawing gases out of the fuel tank and delivering them to said pressure vessel, said compressor fluidically connected to said pressure vessel.

2. The venting device according to claim 1, wherein said pressure vessel has a fuel/gas separator for separating fuel from gas collected by said pressure vessel.

3. The venting device according to claim 1, wherein said pressure vessel has a means for separating fuel from gas collected by said pressure vessel.

4. The venting device according to claim 1, wherein said pressure vessel has a cooling device.

5. The venting device according to claim 4, wherein said cooling device has a Peltier element.

6. The venting device according to claim 1, wherein said compressor and said pressure vessel are disposed inside the fuel tank.

7. The venting device according to claim 1, wherein said pressure vessel has a selectable outlet valve for transferring collected fuel into the fuel tank.

8. The venting device according to claim 1, wherein said pressure vessel is to be connected to an induction duct of an internal-combustion engine of a motor vehicle.

9. The venting device according to claim 8, wherein:
said pressure vessel has a line with a switching valve; and
said line is to be fluidically connected to the induction duct of the internal-combustion engine.

10. The venting device according to claim 9, including an activated carbon filter fluidically connected to said line.

11. The venting device according to claim 10, including a pressure-relief valve disposed upstream of said activated carbon filter.

12. The venting device according to claim 10, including a pressure-relief valve connected between said line and said activated carbon filter.

13. The venting device according to claim 1, wherein said pressure vessel has a line with a switching valve.

14. The venting device according to claim 13, including an activated carbon filter fluidically connected to said line.

15. The venting device according to claim 14, including a pressure-relief valve disposed upstream of said activated carbon filter.

16. The venting device according to claim 14, including a pressure-relief valve connected between said line and said activated carbon filter.

17. The venting device according to claim 1, wherein the fuel tank has a vent valve opening when sub-atmospheric pressure exists in the fuel tank.

18. In a motor vehicle having a fuel tank and an internal-combustion engine with an induction duct, a fuel tank venting device, comprising: a pressure vessel for collecting gas in the fuel tank; and a compressor for drawing gases out of the fuel tank and delivering them to said pressure vessel, said compressor fluidically connected to said pressure vessel, said pressure vessel fluidically connected to the induction duct.

19. A fuel tank venting device, comprising:
a pressure vessel for collecting gas in the fuel tank; and
a compressor for drawing gases out of the fuel tank and delivering them to said pressure vessel, said compressor fluidically connected to said pressure vessel.
